(19) United States
(12) Patent Application Publication
(10) Pub. No.: US 2025/0350834 A1
(43) Pub. Date: Nov. 13, 2025

(54) ANTI-SHAKE COMPENSATION METHOD, CAMERA DEVICE, AND COMPUTER-READABLE STORAGE MEDIUM

(71) Applicant: AAC Acoustic Technologies (Shanghai) Co., Ltd., Shanghai (CN)

(72) Inventor: Xiu Wu, Shanghai (CN)

(21) Appl. No.: 19/001,390

(22) Filed: Dec. 24, 2024

Related U.S. Application Data
(63) Continuation of application No. PCT/CN2024/091732, filed on May 8, 2024.

(51) Int. Cl. H04N 23/68; G05B 11/42

(52) U.S. Cl. CPC H04N 23/682; G05B 11/42

(57) ABSTRACT

An anti-shake compensation method, a camera device, and a computer-readable storage medium relate to a field of optical image stabilization are provided. The anti-shake compensation method includes determining, according to sensor data of an actuator in a camera device, whether a lens module where the actuator is located is affected by gravity; when the lens module where the actuator is located is affected by the gravity, determining an anti-shake compensation amount according to a gravity compensation coefficient of the camera device; and performing anti-shake compensation on the lens module where the actuator is located in the camera device according to the anti-shake compensation amount. The anti-shake compensation amount overcomes an influence of the gravity. The influence of the gravity in an anti-shake process is considered, so as to improve an anti-shake capability of the camera device and further improve stability of an image.

### TECHNICAL FIELD

The present disclosure relates to a field of optical image stabilization, and in particular to an anti-shake compensation method, a camera device, and a computer-readable storage medium.

### BACKGROUND

With rapid development of science and technology and with continuous innovation of various industries, importance of optical image stabilizer (OIS) technology in photography and visual applications becomes more prominent. The OIS effectively reduces image jitter caused by vibration of a camera device, handheld photography, or other movements by introducing a control system into an optical system thereof, thereby improving image quality and user experience.

In anti-shake compensation, after an anti-shake compensation amount is calculated, the anti-shake compensation amount is directly applied to a driving device of the camera device to offset the vibration or movement of the camera device and achieve image stabilization. However, a maximum driving force provided by the driving device may unable to meet the anti-shake compensation amount that is relatively large, which leads to a decrease in anti-shake performance of the camera device.

### SUMMARY

A purpose of the present disclosure is to provide an anti-shake compensation method, a camera device, and a computer-readable storage medium, and a driving force provided by a driving device thereof meet a target anti-shake compensation amount of each of segments after division, so as to ensure anti-shake performance of the camera device.

To achieve the above purpose, the present disclosure provides an anti-shake compensation method. The anti-shake compensation method comprises steps:
calculating an anti-shake compensation amount of a camera device according to a proportional-integral-derivative (PID) control algorithm;
when the anti-shake compensation amount is greater than a rated compensation threshold and the fixed anti-shake compensation amount is not greater than the rated compensation threshold, setting the anti-shake compensation amount to be the fixed anti-shake compensation amount; and
performing anti-shake compensation on the camera device by the anti-shake compensation amount equal to the fixed anti-shake compensation amount.

The rated compensation threshold is not greater than a maximum anti-shake amount of the camera device.

In one optional embodiment, the anti-shake compensation method further comprises a step:
when the anti-shake compensation amount is not greater than the rated compensation threshold, performing the anti-shake compensation on the camera device by the anti-shake compensation amount.

In one optional embodiment, the anti-shake compensation method further comprises a step:
adjusting the fixed anti-shake compensation amount according to a stabilization effect of an image captured by the camera device after the anti-shake compensation.

In one optional embodiment, the rated compensation threshold is 70%-80% of the maximum anti-shake amount of the camera device.

In one optional embodiment, the step of calculating the anti-shake compensation amount of the camera device according to the PID control algorithm comprises steps:
determining whether an integral term is saturated in the PID control algorithm in real time;
when the integral term is saturated in the PID control algorithm, updating the integral item in the PID control algorithm; and
calculating the anti-shake compensation amount of the camera device according to an updated integral item.

In one optional embodiment, the anti-shake compensation method further comprises a step:
when the integral term of the PID control algorithm is not saturated, directly calculating the anti-shake compensation amount of the camera device.

In one optional embodiment, the step of updating the integral item in the PID control algorithm comprises:
resetting the integral term.

In one optional embodiment, the step of calculating the anti-shake compensation amount of the camera device according to the updated integral item comprises:
updating a proportional term and a differential term in the PID control algorithm; and
calculating the anti-shake compensation amount based on the updated integral term, an updated proportional term, and an updated differential term.

The present disclosure further provides a camera device. The camera device comprises at least one processor and a memory in communication with the at least one processor. The memory stores instructions executable by the at least one processor, and when the instructions are executed by the at least one processor, the at least one processor executes the anti-shake compensation method mentioned above.

The present disclosure further provides a computer-readable storage medium. The computer-readable storage medium comprises computer programs stored therein. The computer programs are executed by at least one processor to implement the anti-shake compensation method mentioned above.

In the embodiments of the present disclosure, the anti-shake compensation amount of the camera device is calculated according to the PID control algorithm, when the anti-shake compensation amount is greater than the rated compensation threshold, the anti-shake compensation amount is set to be the fixed anti-shake compensation amount, and the anti-shake compensation is performed on the camera device by the fixed anti-shake compensation amount. The fixed anti-shake compensation amount is not greater than the rated compensation threshold, and the rated compensation threshold is not greater than the maximum anti-shake amount of the camera device. In the present disclosure, by setting the anti-shake compensation amount to be the fixed anti-shake compensation amount, when the fixed anti-shake compensation amount is applied to perform the anti-shake compensation on the camera device, the driving force provided by the driving device meets the fixed anti-shake compensation amount, thereby ensuring the anti-shake performance of the camera device.

### BRIEF DESCRIPTION OF DRAWINGS

One or more embodiments are exemplarily described by pictures in corresponding drawings, and these exemplary descriptions do not constitute limitations on the embodiments.

FIG. 1 is a flow chart of an anti-shake compensation method according to a first embodiment of the present disclosure.

FIG. 2 is a flow chart of the anti-shake compensation method according to a second embodiment of the present disclosure.

FIG. 3 is a schematic diagram of an anti-integral saturation circuit according to one embodiment of the present disclosure.

FIG. 4 is a flow chart of the anti-shake compensation method according to a third embodiment of the present disclosure.

FIG. 5 is a schematic structural diagram of a camera device according to one embodiment of the present disclosure.

### DETAILED DESCRIPTION

To make objectives, technical solutions, and advantages of embodiments of the present disclosure clearer, the following describes the embodiments of the present disclosure in detail with reference to the accompanying drawings. However, it should be understood by those of ordinary skill in the art that in various embodiments of the present disclosure, many technical details are set forth in order to make a reader better understand the present disclosure. However, even without these technical details and various changes and modifications based on the following embodiments, technical solutions claimed in the present disclosure may allow to be implemented. The following division of the embodiments is for convenience of description, and should not constitute any limitation on the specific implementations of the present disclosure, and the various embodiments may be combined with each other without contradiction.

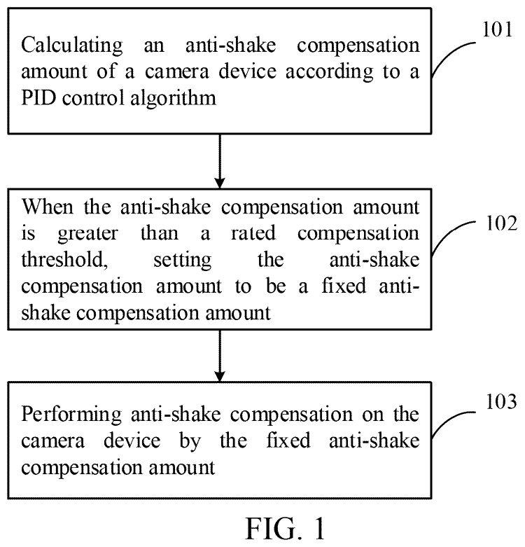

To solve a problem of a decrease in anti-shake performance of a camera device caused by a maximum driving force provided by a driving device thereof being unable to meet an anti-shake compensation amount that is relatively large, the present disclosure provides an anti-shake compensation method. FIG. 1 is a flow chart of the anti-shake compensation method according to a first embodiment of the present disclosure. As shown in FIG. 1, the anti-shake compensation method is applied to a camera device. The anti-shake compensation method comprises steps 101-103.

The step 101 comprises calculating an anti-shake compensation amount of a camera device according to a proportional-integral-derivative (PID) control algorithm.

The PID algorithm is a closed-loop control method. PID represents proportional, integral, and derivative, which are respectively corresponding to a proportional term, an integral term, and a differential term.

A deviation/error of an image of the camera device, and the deviation/error refers to a distance between a target position and an actual position or an angle difference between the target position and the actual position of the image. An output value of the PID control algorithm is calculated according to the deviation/error, which is obtained by a weighted sum of the proportional term, the integral term, and the differential term. The proportional term is a product of a proportional gain and a current error, and the proportional term is configured to correct the current error. The integral term is a product of an integral gain and an error accumulation, and the integral term is configured to eliminate steady-state errors. The differential term is a product of a differential gain and an error change rate, the differential term is configured to suppress system oscillations.

The anti-shake compensation amount is the output value of the PID control algorithm. The anti-shake compensation is applied to the camera device to correct a position or an angle of the image. The anti-shake compensation amount is the sum of the proportional term, the integral term, and the differential term.

The step 102 comprises when the anti-shake compensation amount is greater than a rated compensation threshold, setting the anti-shake compensation amount to be a fixed anti-shake compensation amount.

The rated compensation threshold is not greater than a maximum anti-shake amount of the camera device. For example, according to actual situations and experienced anti-shake driving force, the rated compensation threshold is in a range of 70%-80% of the maximum anti-shake amount of the camera device. In the range, the anti-shake driving force is better. Of course, the rated compensation threshold may be in other proportion of the maximum anti-shake amount of the camera device, which is determined based on performance of the camera device, photographic conditions, and user preferences. The rated compensation threshold may be a fixed value or dynamically adjusted according to a real-time situation, which is not specifically limited thereto.

If the anti-shake compensation amount is greater than the rated compensation threshold, a maximum driving force provided by the driving device may not meet the anti-shake compensation amount, thereby causing the decrease of the anti-shake performance of the camera device. Therefore, the anti-shake compensation amount is set to be the fixed anti-shake compensation amount, and the anti-shake compensation is performed on the camera device through the fixed anti-shake compensation amount. The fixed anti-shake compensation amount is not greater than the rated compensation threshold. At this time, for the fixed anti-shake compensation amount, the driving device is capable of providing a corresponding driving force.

The step 103 comprises performing anti-shake compensation on the camera device by the anti-shake compensation amount equal to the fixed anti-shake compensation amount.

At a current moment (a current frame), only an anti-shake amount from 0 to a segment point is configured to anti-shake. The anti-shake amount is the fixed anti-shake compensation amount, and an exceeding anti-shake amount is ignored. Same operation of the steps 101-103 is repeated for a next frame.

In the present disclosure, by setting the anti-shake compensation amount to be the fixed anti-shake compensation amount, when the fixed anti-shake compensation amount is applied to perform the anti-shake compensation on the camera device, the driving force provided by the driving device meets the fixed anti-shake compensation amount, thereby ensuring the anti-shake performance of the camera device.

Based on the anti-shake compensation method shown in FIG. 1, one embodiment of the present disclosure further provides another anti-shake compensation method. The anti-shake compensation method comprises a step of performing the anti-shake compensation on the camera device by the anti-shake compensation amount. when the anti-shake compensation amount is not greater than the rated compensation threshold. That is, the anti-shake compensation amount is directly applied to the camera device, and the driving force provided by the driving device adjusts a position or an angle of the camera device or a lens to offset the deviation of the image, thereby achieving anti-shake compensation to enhance image stability.

In the embodiment of the present disclosure, when the anti-shake compensation amount is not greater than the rated compensation threshold, that is, when the driving force provided by the driving device is unable to meet the anti-shake compensation amount, the anti-shake compensation amount is not adjusted, and the anti-shake compensation under normal circumstances is achieved to ensure the anti-shake performance of the camera device.

Based on the anti-shake compensation method shown in FIG. 1, one embodiment of the present disclosure further provides another anti-shake compensation method. The anti-shake compensation method comprises adjusting the fixed anti-shake compensation amount according to a stabilization effect of an image captured by the camera device after the anti-shake compensation, observing areal-time stabilization effect and a real-time image quality, and adjusting the fixed compensation threshold as needed.

High-quality indexes of the stabilization effect and the image quality are determined, the high-quality indexes comprise an image clarity index, a stability index, a contrast index, etc. The stabilization effect and the image quality of the image after anti-shake compensation is determined, and the stabilization effect and the image quality of the image are compared with the high-quality indexes. If tabilization effect and the image quality of the image do not meet a standard, the fixed compensation threshold is adjusted.

The fixed compensation threshold is adjusted by reducing the fixed compensation threshold. The anti-shake compensation amount is divided by a reduced fixed compensation threshold, so as to continuously improve the anti-shake effect of the camera device until the stabilization effect of the image captured by the camera device reaches the high quality indexes.

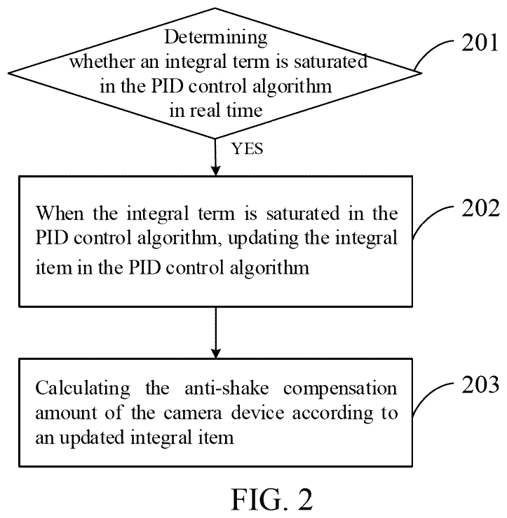

Based on the anti-shake compensation method shown in FIG. 1, the present disclosure further provides a second embodiment of the anti-shake compensation method. FIG. 2 is a flow chart of the anti-shake compensation method according to the second embodiment of the present disclosure. As shown in FIG. 2, the step 101 of calculating the anti-shake compensation amount of the camera device according to the PID control algorithm comprises steps 201-203.

The step 201 comprises determining whether the integral term is saturated in the PID control algorithm in real time;

The application of PID control algorithm in anti-shake stabilizes an anti-shake system, but the PID control algorithm may have a problem of integral term saturation. The integral term saturation means that a value of the integral term exceeds a limit range of an output of a controller of the camera device, which may cause the anti-shake system to over-respond and lose stability. Specifically, when the integral term saturates, the output of the controller is limited, which affects a calculation of the anti-shake compensation amount. Specifically, the integral term saturation may result in insufficient calculation or delayed calculation of the anti-shake compensation amount, thereby affecting a suppression effect of the anti-shake system on vibration or movement.

Therefore, it is necessary to deal with the integral term saturation in real time. Before dealing with the integral term saturation, it is necessary to determine in real time whether the integral term saturation occurs in the PID control algorithm.

In one optional embodiment, whether the integral term is saturated is determined by monitoring an accumulated value of the integral term. Specifically, when the integral term is saturated, it means that an accumulated value of the integral term continuing increase to exceed the limit range of the anti-shake system. Therefore, whether the integral term is saturated is determined by monitoring the accumulated value of the integral term. If an absolute value of the integral term or a growth rate of the integral term exceeds a certain threshold, it is determined that the integral term is saturated.

In another optional embodiment, when a PID controller (i.e., the controller mentioned above) is designed, the limit range on the integral term is determined to prevent the accumulated value from being too large to case the integral term saturation. When the integral term approaches or reaches a predetermined limit, it is determined that the integral term is saturated.

In another optional embodiment, whether the integral term is saturated is determined by observing response the anti-shake system. Specifically, when the integral term is saturated, the anti-shake system exhibits instability or over-regulation. Therefore, by observing actual response of the anti-shake system, such as an increase in a vibration frequency, over-regulation, or a deviated target value of the anti-shake system, it is indirectly determined that whether the integral term is saturated.

In another optional embodiment, change of the output of the PID controller is monitored, and especially an impact of the integral term on the output is monitored. If the change of the integral term has a significant impact on the output of the PID controller, and the output of the PID controller is unstable or abnormal, it is determined that the integral term is saturated.

In another optional embodiment, a PID regulator comprises a built-in saturation detection algorithm that is able to monitor whether the output of the PID controller is saturated in real time. The built-in saturation detection algorithm determines whether the integral term is saturated based on a relationship between the output of the PID controller and the limit range. When the output nearly reaches the limit range, the built-in saturation detection algorithm is triggered.

Of course, other methods may be adopted to determine whether the integral term of the PID control algorithm is saturated, which is not specifically limited in the embodiments of the present disclosure.

The step 202 comprises when the integral term is saturated in the PID control algorithm, updating the integral item in the PID control algorithm.

when the integral term of the PID control algorithm is not saturated, the anti-shake compensation amount of the camera device is directly calculated according to the anti-shake error.

When the integral term of the PID control algorithm is saturated, an anti-integral saturation strategy is required. In the embodiment of the present disclosure, the anti-saturation integral strategy is to update the integral term in the PID control algorithm. Specifically, the integral term is reset, that is, the integral term is cleared to zero. Specifically, an input of the integral term is set to zero.

Of course, the updated integral term may set to be a small initial value, or the growth rate or the accumulated value of the integral term is limited to prevent excessive growth of the integral term from causing saturation, which is not specifically limited in the embodiment of the present disclosure.

The step 203 comprises calculating the anti-shake compensation amount of the camera device according to an updated integral item.

The anti-shake compensation amount of the camera device is recalculated based on the updated integral term in the PID control algorithm.

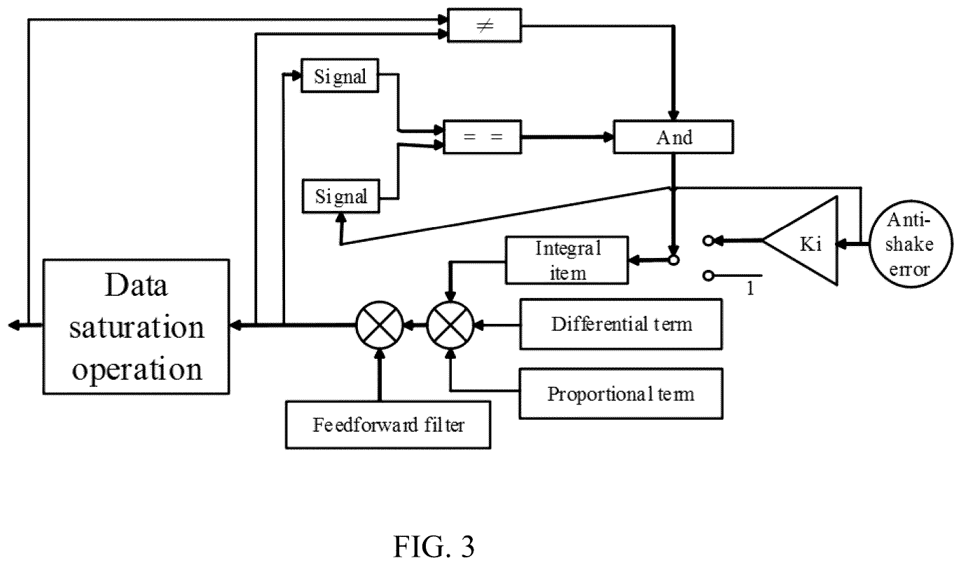

The embodiment of the present disclosure provides an anti-integral saturation circuit. FIG. 3 is a schematic diagram of the anti-integral saturation circuit according to one embodiment of the present disclosure. As shown in FIG. 3, the step of determining whether the integral item is saturated comprises determining whether a sum of the output of the PID controller and an output of a feedforward filter of the camera device exceeds a driving threshold; if yes, determining that the integral term is saturated, and enabling an output logic value of a data saturation operation to be 0; and if no, enabling the output logic value of the data saturation operation to be 1.

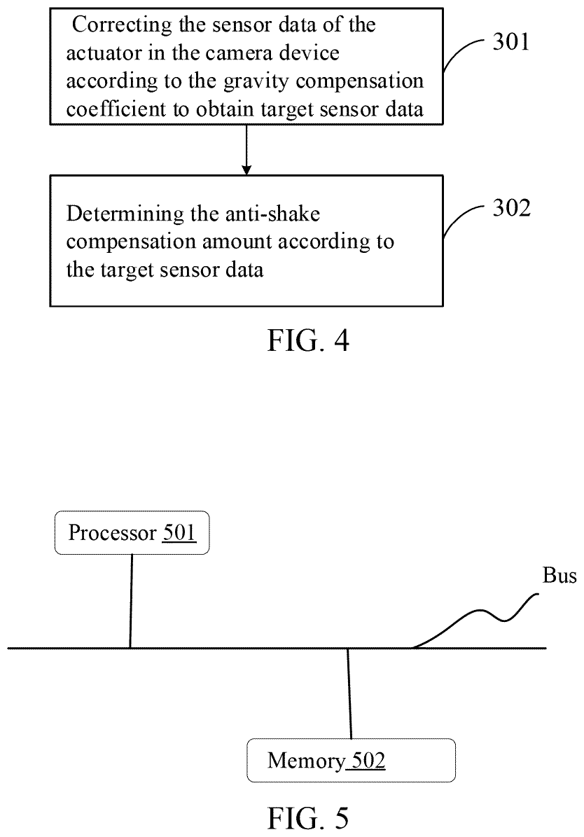

A logic value of the sum of the output of the PID controller and the output of the feedforward filter is 1. The output logic value of the data saturation operation is compared with the logic value 1 of the sum of the output of the PID controller and the output of the feedforward filter (≠ in FIG. 4). If the output logic value of the data saturation operation is not equal to the logic value 1 of the sum of the output of the PID controller and the output of the feedforward filter, an output logic value of an unequal comparison operation is 1. If the output logic value of the data saturation operation is equal to the logic value 1 of the sum of the output of the PID controller and the output of the feedforward filter, an output logic value of the unequal comparison operation is 0. For example, when the sum of the output of the PID controller and the output of the feedforward filter exceeds the driving threshold, the output logic value of the data saturation operation is 0, which is compared with the logic value 1 of the sum of the output of the PID controller and the output of the feedforward filter, The output logic value of the data saturation operation is not equal to the logic value 1 of the sum of the output of the PID controller and the output of the feedforward filter, so the output logic value of the unequal comparison operation is 1.

An equal comparison operation is performed on a sign of an output logic value of the anti-shake error and a sign of the logic value of the sum of the output of the PID controller and the output of the feedforward filter (= in FIG. 4). when the signs are the same, an output logic value of the equal comparison operation is 1, and when the signs are different, the output logic value of the equal comparison operation is 0.

When the sign of the output logic value of the anti-shake error is the same as the sign of the logic value of the sum of the output of the PID controller and the output of the feedforward filter, an output logic value of the equal comparison operation is 1. Meanwhile, when the sum of the output of the PID controller and the output of the feedforward filter exceeds the driving threshold, the output logic value of the data saturation operation is 0, and the output logic value of the unequal comparison operation is 1. The output logic value of the equal comparison operation and the output logic value of the unequal comparison operation are input to the logic and operation (AND in FIG. 4), and both the two input logic values of the logic and operation are 1, so an output logic value of the logic and operation is 1.

The output logic value of the logic and operation is configured to control a single-pole double-throw switch. When the output logic value of the logic and operation is 1, an input end of the single-pole double-throw switch is connected to a 0 end, that is, the integral term is reset to be 0.

Data output by the anti-integral saturation circuit is a control system output of the PID controller combined proportional control and differential control, and the feedforward filter term.

In the embodiment of the present disclosure, by resetting the integral term in the PID control algorithm to deal with the saturation of the integral term, so the calculation of the anti-shake compensation amount is not delayed, thereby ensuring the suppression effect of the vibration or the movement and ensuring the anti-shake effect.

Based on the anti-shake compensation method shown in FIG. 2, the present disclosure further provides a third embodiment of the anti-shake compensation method. FIG. 3 is a flow chart of the anti-shake compensation method according to the third embodiment of the present disclosure. As shown in FIG. 4, the step 203 of calculating the anti-shake compensation amount of the camera device according to the updated integral item comprises steps 401-402.

The step 401 comprises updating the proportional term and the differential term in the PID control algorithm.

When the integral term of the PID control algorithm is saturated, it is generally not enough to change only the integral term in the PID control algorithm. Although adjusting the integral term alleviates the integral term saturation, in some cases, only adjusting the integral term may not completely solve the integral term saturation because the integral term saturation may be caused by nature of the anti-shake system itself or environmental factors.

When the anti-shake system responds slowly due to a limitation in the integral term, the proportional term is increased to increase sensitivity of the PID controller to the anti-shake error and speed up the response of the anti-shake system. When the anti-shake system over-adjusts or oscillates due to the limitation in the integral term, the proportional term needs to be reduced to reduce a gain of the PID controller and make the anti-shake system more stable.

When the system has a large overshoot or oscillation due to the limitation in the integral term, the differential term is increased to improve the suppression effect of the PID controller and reduce the overshoot or the oscillation. When the system is overly sensitive or jitters cue to the limitation in the integral term, the differential term is reduced to reduce a response of the PID controller to an error change rate and make the anti-shake system more stable.

Of course, the proportional term and the differential term in the PID control algorithm may be updated by other methods, which are not specifically limited in the embodiments of the present disclosure.

The step 402 comprises calculating the anti-shake compensation amount based on the updated integral term, an updated proportional term, and an updated differential term.

The anti-shake compensation amount of the camera device is recalculated based on the updated integral term, the updated proportional term, and the updated differential term in the the PID control algorithm.

In the embodiment of the present disclosure, by updating the integral term, the proportional term, and the differential term in the PID control algorithm to deal with the integral term saturation, the anti-shake system is more stable and the anti-shake effect is enhanced.

The above steps of the present disclosure are divided only for a purpose of clear description. When implementing, the steps may be combined into one step or at least part of the steps may be divided and decomposed into sub-steps. As long as the steps comprise the same logical relationship, the steps are within the protection scope of the present disclosure. Technical solutions adding insignificant modifications to the algorithm or process or introducing insignificant designs without changing the core design of the algorithm and process, should fall within the protection scope of the present disclosure.

The present disclosure further provides a camera device. FIG. 5 is a schematic structural diagram of a camera device according to one embodiment of the present disclosure. As shown in FIG. 5, the camera device comprises at least one processor 501 and a memory 502 in communication with the at least one processor 501. The memory 501 stores instructions executable by the at least one processor 501, and when the instructions are executed by the at least one processor 501, the at least one processor 501 executes the anti-shake compensation method mentioned above.

The memory 502 and the at least one processor 501 are connected by a bus, which may comprise any number of interconnected buses and bridges, and the bus connects circuits of at least one processors 501 and circuit of the memory 502 together.

The at least one processor 501 is responsible for managing the bus and general processing. The at least one processor 501 has various functions. The memory 502 is configured to store data executed by the at least one processor 501.

The present disclosure further provides a computer-readable storage medium. The computer-readable storage medium comprises computer programs stored therein. The computer programs are executed by at least one processor to implement the anti-shake compensation method mentioned above.

Those skilled in the art can understand that all or part of the steps in the above-mentioned embodiments may be completed by instructing relevant hardware through the programs. The programs are stored in the computer-readable storage medium and comprises instructions for a device (such as a single-chip microcomputer, chip, etc.) or the at least one processor to perform all or part of the steps of the methods described in various embodiments of the present disclosure. The computer-readable storage medium may be a USB flash drive, a mobile hard drive, a read-only memory (ROM), a random access memory (RAM), disk, optical disk, or other medium that is able to store program codes.

Those skilled in the art can understand that the embodiments are specific embodiments of the present disclosure, and in actual applications, various changes can be made to them in form and details without departing from the spirit and scope of the present disclosure.

What is claimed is:

1. An anti-shake compensation method, comprising steps:
calculating an anti-shake compensation amount of a camera device according to a proportional-integral-derivative (PID) control algorithm;
when the anti-shake compensation amount is greater than a rated compensation threshold and the fixed anti-shake compensation amount is not greater than the rated compensation threshold, setting the anti-shake compensation amount to be the fixed anti-shake compensation amount; and
performing anti-shake compensation on the camera device by the anti-shake compensation amount, the anti-shake compensation amount being equal to the fixed anti-shake compensation amount;
wherein the rated compensation threshold is not greater than a maximum anti-shake amount of the camera device.

2. The anti-shake compensation method according to claim 1, wherein the anti-shake compensation method further comprises a step:
when the anti-shake compensation amount is not greater than the rated compensation threshold, performing the anti-shake compensation on the camera device by the anti-shake compensation amount.

3. The anti-shake compensation method according to claim 1, wherein the anti-shake compensation method further comprises a step:
adjusting the fixed anti-shake compensation amount according to a stabilization effect of an image captured by the camera device after the anti-shake compensation.

4. The anti-shake compensation method according to claim 1, wherein the rated compensation threshold is 70%-80% of the maximum anti-shake amount of the camera device.

5. The anti-shake compensation method according to claim 1, wherein the step of calculating the anti-shake compensation amount of the camera device according to the PID control algorithm comprises steps:
determining whether an integral term is saturated in the PID control algorithm in real time;
when the integral term is saturated in the PID control algorithm, updating the integral item in the PID control algorithm; and
calculating the anti-shake compensation amount of the camera device according to an updated integral item.

6. The anti-shake compensation method according to claim 5, wherein the anti-shake compensation method further comprises a step:
when the integral term of the PID control algorithm is not saturated, directly calculating the anti-shake compensation amount of the camera device.

7. The anti-shake compensation method according to claim 5, wherein the step of updating the integral item in the PID control algorithm comprises:
resetting the integral term.

8. The anti-shake compensation method according to claim 5, wherein the step of calculating the anti-shake compensation amount of the camera device according to the updated integral item comprises:
updating a proportional term and a differential term in the PID control algorithm; and
calculating the anti-shake compensation amount based on the updated integral term, an updated proportional term, and an updated differential term.

9. A camera device, comprising:
at least one processor; and,
a memory in communication with the at least one processor;
wherein the memory stores instructions executable by the at least one processor, and when the instructions are executed by the at least one processor, the at least one processor executes the anti-shake compensation method according to claim 1.

10. A computer-readable storage medium, comprising computer programs stored therein;
wherein the computer programs are executed by at least one processor to implement the anti-shake compensation method according to claim 1.
